(19) United States
(12) Patent Application Publication
(10) Pub. No.: US 2010/0149952 A1
(43) Pub. Date: Jun. 17, 2010

(54) OPTICAL PICKUP DEVICE AND OPTICAL DISC APPARATUS USING THE SAME

(76) Inventor: Toshiteru NAKAMURA, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/608,131

(22) Filed: Oct. 29, 2009

(30) Foreign Application Priority Data
Dec. 15, 2008 (JP) 2008-317832

(51) Int. Cl. G11B 7/135

(52) U.S. Cl. 369/112.12; G9B/7.112

(57) ABSTRACT

An optical pickup device and an optical disc apparatus which is capable to reduce variation of a detected signal due to unnecessary beam and detect a signal with high quality are provided. Amplification of sup PP signals necessary to produce a tracking error signal by a DPP method can be realized by an amplification factor smaller than a spectral radio of main and sub beams by the following structure. The optical pickup device includes an optical element having an area in which part of beam is diffracted and light shielding zones or insensitive zones having predetermined width are formed on center division lines in the light receiving planes of sub beams of the optical detector. The shape of a diffraction area is optimized to the shift amount of objective lens. The width of the light shielding zones or insensitive zones is optimized from the shift amount of objective lens and the shape of the diffraction area. With such structure, it is possible to suppress interferential disturbance component due to unnecessary light produced in sub PP signals from being amplified by an amplifier and the tracking error signal having less waveform fluctuation can be detected stably and satisfactorily even upon reproduction/recording of a multi-layered disc.

### INCORPORATION BY REFERENCE

The present application claims priority from Japanese application JP2008-317832 filed on Dec. 15, 2008, the entire content of which is hereby incorporated by reference into this application.

### BACKGROUND OF THE INVENTION

The present invention relates to an optical pickup device and an optical disc apparatus using the same.

As a background technique of this technical field, JP-A-2006-344344, for example, may be referred to. This patent publication discloses that “a desired signal is obtained with high accuracy from an optical disc having a plurality of recording layers”. Furthermore, JP-A-2006-344380, for example, may be referred to. This patent publication discloses that “even when an optical recordable storage medium having two information recording sides is used, a tracking error signal having less offset is detected”.

### SUMMARY OF THE INVENTION

Recently, upon recording/reproduction of an optical disc having recording layers in the multi-layered form, an unnecessary beam reflected by a recording layer from which a signal is not to be reproduced enters the plane of an optical detector to be disturbance component, so that a detected signal of the optical detector is varied. Particularly, in the optical disc having 3 or more recording layers in the multi-layered form, unnecessary beams are produced in plural layers and accordingly the disturbance component is increased, so that variation of the detected signal is also increased greatly.

The variation due to the unnecessary beam of the detected signal can be suppressed by the measures described in the above patent publication JP-A-2006-344344. However, the measures described in this patent publication require a large number of additional optical parts or components and very high accuracy of component-mounting position, so that the optical pickup device is expensive.

It is an object of the present invention to provide an optical pickup device and optical disc apparatus with lower cost and good mass-productivity which can reduce leakage of the disturbance component due to unnecessary beam into the detected signal and detect the signal with high quality.

The above object can be achieved by the invention described in the claims.

According to the present invention, there can be provided the optical pickup device and optical disc apparatus which can reduce influence of disturbance due to unnecessary beam to the detected signal and detect the signal with high quality.

### BRIEF DESCRIPTION OF THE DRAWINGS

These and other features, objects and advantages of the present invention will become more apparent from the following description when taken in conjunction with the accompanying drawings wherein:

FIG. 1 is a schematic diagram illustrating an optical system of an optical pickup device according to a first embodiment of the present invention;

FIG. 2 is a schematic diagram illustrating an example of a prior-art optical detector;

FIG. 3 shows positions of optical spots upon lens shift in the prior-art optical detector;

FIG. 4 illustrates optical paths of beams incident on a multi-layered optical disc;

FIG. 5 is a graph showing that fluctuation of DPP signal is changed depending on amplification factors K2;

FIG. 6 shows the shape of a diffraction area of an optical element which is a primary part of the optical pickup device according to the first embodiment;

FIG. 7A shows the shape of light receiving planes of an optical detector which is a primary part of the optical pickup device according to the first embodiment and arrangement of signal beam spots irradiated thereon;

FIG. 7B shows the shape of light receiving planes of the optical detector upon lens shift and arrangement of the signal beam spots irradiated upon lens shift;

FIG. 8 is a schematic diagram illustrating a signal operation method of output signals of the optical detector of the first embodiment;

FIG. 9 is a schematic diagram illustrating an example of the shape of the light receiving planes of the optical detector capable of making detection using any of sub PP signal in the first embodiment and sub PP signal in the prior art;

FIG. 10 is a schematic diagram illustrating an optical detector which is a primary part according to a second embodiment of the present invention; and

FIG. 11 is a schematic diagram illustrating an example of the optical disc apparatus in which the optical pickup device according to the present invention is mounted.

### DESCRIPTION OF THE EMBODIMENTS

Embodiments of the present invention are now described in detail with reference to the accompanying drawings. The same reference numerals are given to constituent elements having the same operation throughout the drawings.

### Embodiment 1

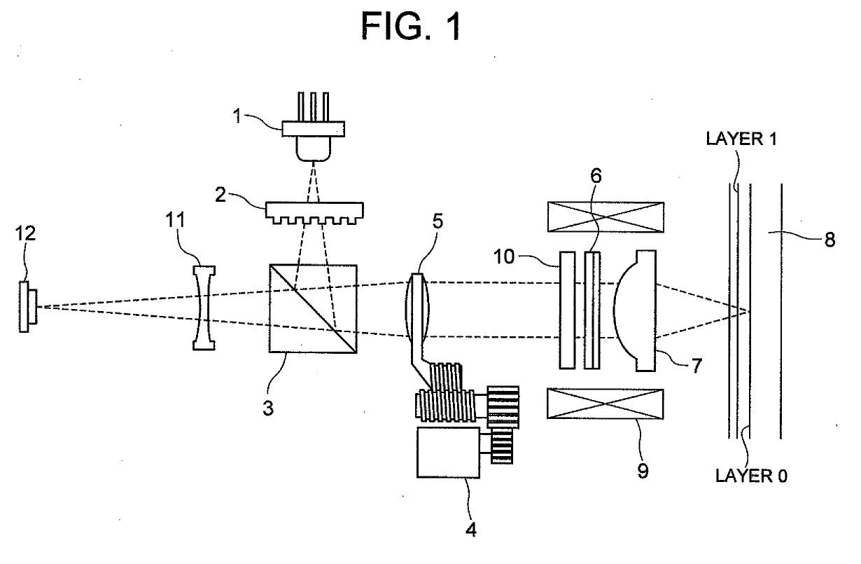

FIG. 1 is a schematic diagram illustrating an example of an optical pickup device according to a first embodiment of the present invention. A laser beam emitted from a laser light source 1 enters a diffraction grating 2 constituting a beam division element to be divided into a main beam of zero-order diffracted light and two sub beams including ±first-order diffracted light. Traveling direction of each beam is changed by a polarizing beam splitter 3, so that each beam is independently focused on a predetermined recording layer in an optical disc 8 by means of an objective lens 7 through a collimator lens 5 having the spherical aberration of incident beams capable of being corrected by driving of a stepping motor 4, an optical element 10 having diffraction area in which parts of the main and sub beams are diffracted and a quarter wavelength plate 6 which gives a phase difference of 90 degrees to polarization components traveling orthogonally to each other.

Reflected beams from the optical disc 8 pass through the objective lens 7 again and then enter an optical detector 12 through the quarter wavelength plate 6, the optical element 10, the collimator lens 5, the polarizing beam splitter 3 and a detection lens 11.

The objective lens 7, the quarter wavelength plate 6 and the optical element 10 are desirably mounted within an actuator 9 for driving them in a predetermined direction. A tracking error signal described later is fed back to the actuator to perform position control of the objective lens, so that tracking control is performed. Moreover, the spherical aberration correction means may be liquid crystal element or the like.

It is preferable that the optical detector 12 detects the tracking error signal by a DPP or DPD method. The DPP method is now described briefly.

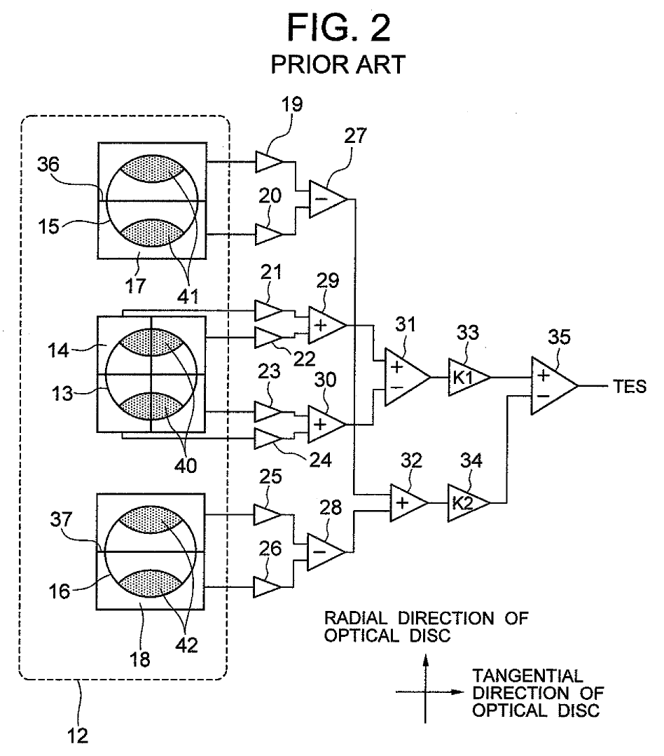

FIG. 2 is a schematic diagram illustrating an example of a prior-art optical detector, showing an example of DPP detection method. A light receiving area 14 on which a focused spot 13 of the main beam reflected by the optical disc is impinged and light receiving areas 17 and 18 on which focused spots 15 and 16 of the sub beams reflected by the optical disc are impinged are arranged in the optical detector. The light receiving area 14 of the main beam is divided by 2 division lines substantially perpendicular to each other into 4 light receiving planes and the light receiving areas 17 and 18 of the sub beams are divided by division lines substantially perpendicular to the direction corresponding to the radial direction of the optical disc into two light receiving planes, respectively. Furthermore, in FIG. 2, the direction corresponding to the radial direction of the optical disc on the optical detector is shown by arrow (in the vertical direction of FIG. 2). Currents are produced from the divided light receiving planes in accordance with the intensity of each incident light and converted into voltages independently by current-voltage conversion amplifiers 19 to 26, respectively. Thereafter, the converted voltages are supplied to subtractors 27, 28 and 31 to be subjected to subtraction, so that a push-pull signal of the main beam 13 (hereinafter referred to as main PP signal for simplification) and an addition signal of push-pull signals of the sub beams 15, 16 (hereinafter referred to as sub PP signal for simplification) are produced.

The main and sub beams are impinged on the optical disc at spaces of half track and the 2 sub beams are impinged on the optical disc at space of one track. Accordingly, the main and sub PP signals are produced with phase shifted by 180 degrees each other. In FIG. 2, an area in which the main PP signal is obtained is represented by 40 and areas in which the sub PP signals are obtained are represented by 41 and 42.

Accordingly, the main and sub PP signals are subjected to subtraction, so that unnecessary direct current component and disturbance component of the same phase contained both of them can be canceled or corrected.

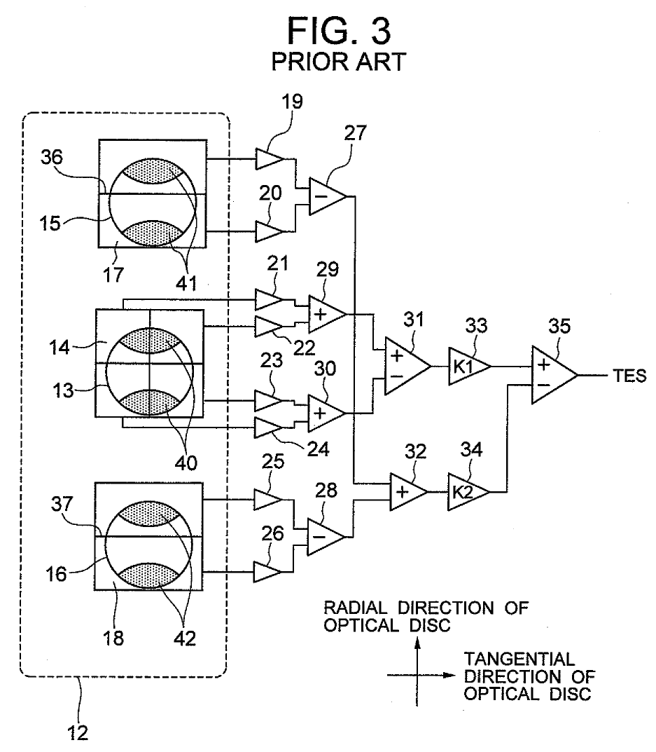

Particularly, the effect of the DPP method is exhibited when the objective lens is shifted in the radial direction. FIG. 3 shows positions of beam spots on the optical detector when the objective lens is shifted in the radial direction. When the objective lens is shifted in the radial direction, the positions of the beam spots on the plane of the optical detector is also moved in the direction corresponding to the radial direction of the optical disc. As a result, areas of the main and sub beam spots incident on light receiving plane areas of the optical detector for the main and sub beams are changed, so that DC signal offsets are produced in the main and sub PP signals. The DPP method can cancel the offset of the main PP signal by the offset of the sub PP signals generated upon lens shift similarly and can detect a satisfactory tracking error signal even when the objective lens is shifted, so that high-accuracy tracking control can be attained stably.

However, generally, the spectral ratio of the diffraction grating 2 is set so that the light amount of the sub beam is smaller than that of the main beam. As a result, the offset amount of the sub PP signal generated by shift of the objective lens is smaller in accordance with the spectral ratio of the diffraction grating as compared with the offset amount of the main PP signal generated in accordance with the same lens shift amount, so that sufficient offset canceling effect cannot be obtained only by subtraction of the main and sub PP signals. Accordingly, in order to correct difference of the offset occurrence sensitivity due to the lens shift, subtraction is made by a subtractor 35 after the sub PP signals are amplified by an amplifier 34, so that unnecessary offset due to lens shift can be canceled. Accordingly, in the DPP method, the amplification factor K2 is set to be equal to the spectral ratio, so that sufficient offset canceling effect can be obtained upon lens shift.

As described above, the DPP method can remove the offset of the tracking error signal caused by displacement of tracking of the objective lens by the simple optical system configuration and detect the tracking error signal with high quality stably. In this manner, the DPP method is a detection method used widely from its availability.

The position control of the objective lens in the optical pickup device performs not only the tracking position control but also the focusing position control which is the position control along the optical axis direction. As a control signal detection method used in the focusing position control, an astigmatism method is generally used widely. Similarly to the tracking control, the focusing error signal can be also detected by subjecting detection signals from light receiving planes of the optical detector shown in FIG. 2 to predetermined operation processing. Furthermore, information on the optical disc can be read by change in the total light amount of the main beam 13 and accordingly change in a sum signal of output signals of the current-voltage conversion amplifiers 19 to 22 (hereinafter referred to as information reproduction signal for simplification) may be monitored.

When the optical pickup device or the optical disc apparatus for performing reproduction/recording of the optical disc having recording layers in the multi-layered form is used, the following problems arise newly.

When reproduction/recording is performed to the multi-layered optical disc, beams are focused on a recording layer to which reproduction/recording of signal is to be performed (hereinafter referred to as target layer) of the recording layers and reflected light thereof is detected. At this time, part of the light amount thereof is not reflected by the target layer and is reflected by recording layer except the target layer (hereinafter referred to as other layer). Beams reflected by the other layer enter or impinge on the light receiving planes of the optical detector along an optical path substantially similar to that of the signal beam from the target layer to be unnecessary beams which prevent exact detection of the signal beam.

The unnecessary beams interfere with the original signal beam on the light receiving plane to cause interference fringes. Light and darkness of the interference fringes disturb balance of the light amount on the light receiving planes and become unnecessary inter-layer interference component, which affects the output signals from the light receiving planes.

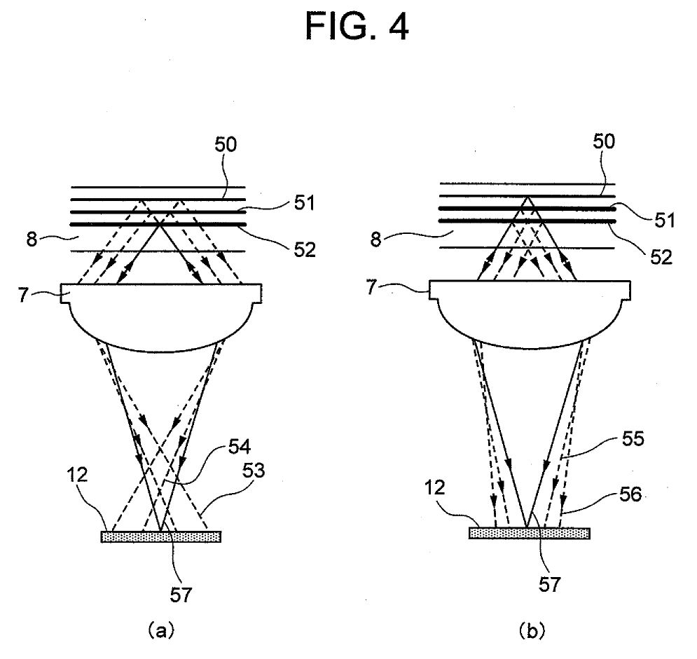

This phenomenon is now described concretely by taking the optical disc 8 including 3 recording layers (spaces between layers δ1 and δ2) as shown in FIG. 4 as an example.

FIG. 4 shows optical paths of beams incident on the multi-layered optical disc. In FIG. 4, the main beam 13 and the sub beams 15, 16 (not shown) are focused on the optical disc 8 having 3 recording layers 50, 51 and 52 formed on one side from the lower side of the drawing. FIG. 4(a) shows the case where the beams are focused on the recording layer 52 (in case where the recording layer 52 is the target layer). In this case, parts of the light amount of the beams focused on the target layer pass through the target layer and are reflected by the recording layers 50 and 51 positioned behind it, so that the reflected beams become unnecessary beams 53 and 54. FIG. 4(b) shows the case where the recording layer 50 is the target layer. In this case, the beams pass through the recording layers 51 and 52 positioned before the recording layer 50 and are then focused on the recording layer 50. However, at this time, parts of the light amount thereof are reflected by the recording layers 51 and 52 and become unnecessary beams 55, 56. Such unnecessary beams 53, 54, 55 and 56 reach the optical detector along the light path substantially similar to the original signal beams. However, the spot sizes on the plane of the optical detector of the unnecessary beams 53, 54, 55 and 56 are different largely from those of the original signal beams 13, 15 and 16 due to difference of the focal positions thereof. Thus, in the multi-layered disc, parts of the unnecessary beams overlap on the light receiving planes a lot in addition to the signal beams to cause complicated interference. Light and darkness of the interference fringes disturb balance of the amount of light detected from the optical detector to vary the output signals. In FIG. 4(a), (b), the signal beams 13, 15 and 16 are unified to be shown as a signal beam 57.

The sub PP signal used to detect the tracking error signal by the DPP method has the signal intensity smaller than the main PP signal generally as described above. The light amount of the unnecessary beams to the signal light of the sub beams is relatively large and accordingly the signal of the optical detector for the sub beam is apt to be affected by disturbance. Particularly, the problem is that when the tracking error signal is produced by the DPP method, the sub PP signal is amplified by the amplifier 34 and accordingly the disturbance component caused by interference of the unnecessary beams is also amplified. Consequently, large waveform distortion and fluctuation occur in the tracking error signal detected by the DPP method, so that the signal quality is deteriorated.

Particularly, when the recording layer is multi-layered, new unnecessary beams occur in a newly provided recording layer. Accordingly, influence of interference due to unnecessary beams on the optical detector plane is further complicated and in addition the relative intensity of the signal light to the unnecessary beam is reduced. Hence, the influence degree of disturbance due to interference in the sub PP signal is increased large and the quality of the tracking error signal is deteriorated remarkably.

Accordingly, if the amplification factor K2 of the amplifier can be suppressed small, amplification of fluctuation due to unnecessary light can be suppressed, so that fluctuation of the DPP signal can be suppressed greatly.

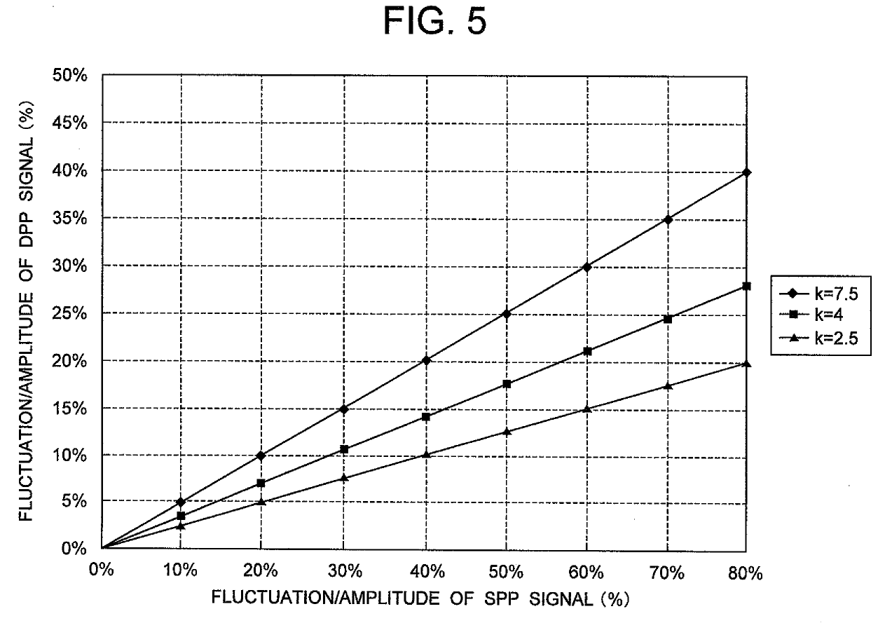

FIG. 5 is a graph showing amplitude of fluctuation in the DPP signal using the amplification factors K2 of the amplifier 34 as parameter when the sub PP signal in which fluctuation due to unnecessary beams is produced is used to calculate the DPP signal. Generally, the spectral ratio of the diffraction grating 2 is set to about 1:10 to 15. Since there are two sub beams, the amplification factor K2 taking the spectral ratio of 1:15, for example, into consideration is about 7.5 equal to a half of 15. In contrast, if the amplification factor K2 can be reduced to about 2.5, fluctuation in the DPP signal can be suppressed to about half as compared with that in the prior art even when fluctuation due to interference having the same magnitude occurs in the sub PP signal. Moreover, when the amplification factor K2 can be suppressed small, there is the merit that amplification of influence in the sub PP signal to defects such as scratch and stain on the disc can be also suppressed to produce the DPP signal.

Accordingly, according to the present invention, the provision of means capable of canceling the offset occurring upon lens shift satisfactorily even when the amplification factor K2 of the amplifier 34 is smaller than the spectral ratio and detecting the tracking error signal by the DPP method can suppress amplification of interferential disturbance component of unnecessary light by the amplifier 34 and detect the tracking error signal having less waveform fluctuation stably and satisfactorily even upon reproduction/recording of the multi-layered optical disc.

In the embodiment, as an example of the means for detecting the tracking error signal by the DPP method satisfactorily even when the amplification factor K2 of the signal amplifier 34 for sub beams is smaller than the spectral ratio, the optical element 10 having a diffraction area in which parts of the main and sub beams are diffracted and the optical detector 12 having belt-shaped light-shielding zones or insensitive zones 62 and 63 disposed on center division lines 36 and 37 of the light receiving planes 15 and 16 of sub beams of the optical detector and in the vicinity thereof and having a width W of a side in the direction corresponding to the radial direction of the optical disc set to have the size described later are used.

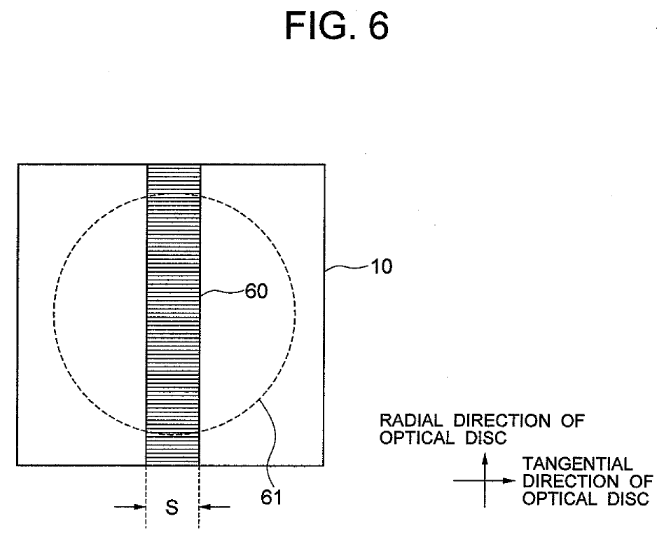

FIG. 6 shows an example of a diffraction area 60 of the optical element 10 used in the embodiment. The diffraction area 60 of the optical element 10 may be, for example, a diffraction grating or a polarization diffraction grating. Moreover, when the diffraction area is formed into a polarization diffraction grating and the quarter wavelength plate 6 is disposed between the optical element 6 and the objective lens 7, the optical element 10 subjects only beams reflected by the optical disc to diffraction and the shape of spot on the optical disc is not affected. In FIG. 6, an effective diameter 61 of a signal beam 57 incident on the diffraction grating is shown together. It is preferable that the diffraction area 60 is formed into a belt-shaped area having a short side of the length S in the direction corresponding to the radial direction of the optical disc.

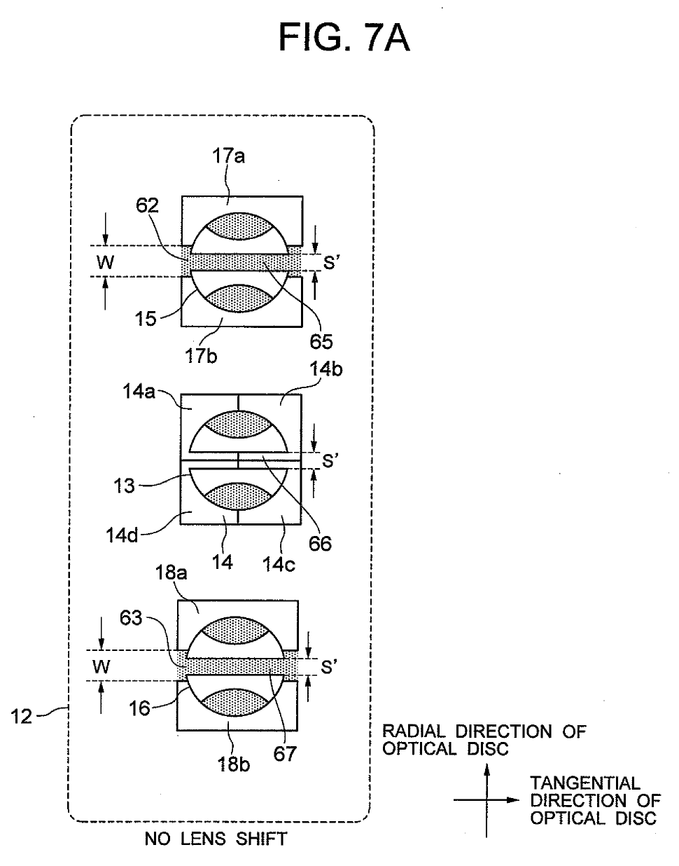

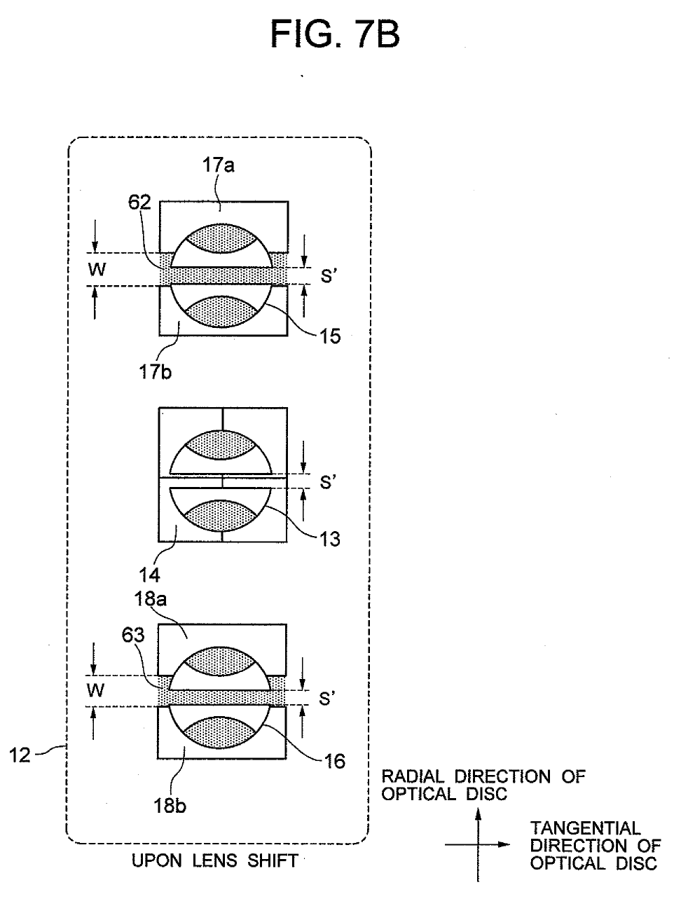

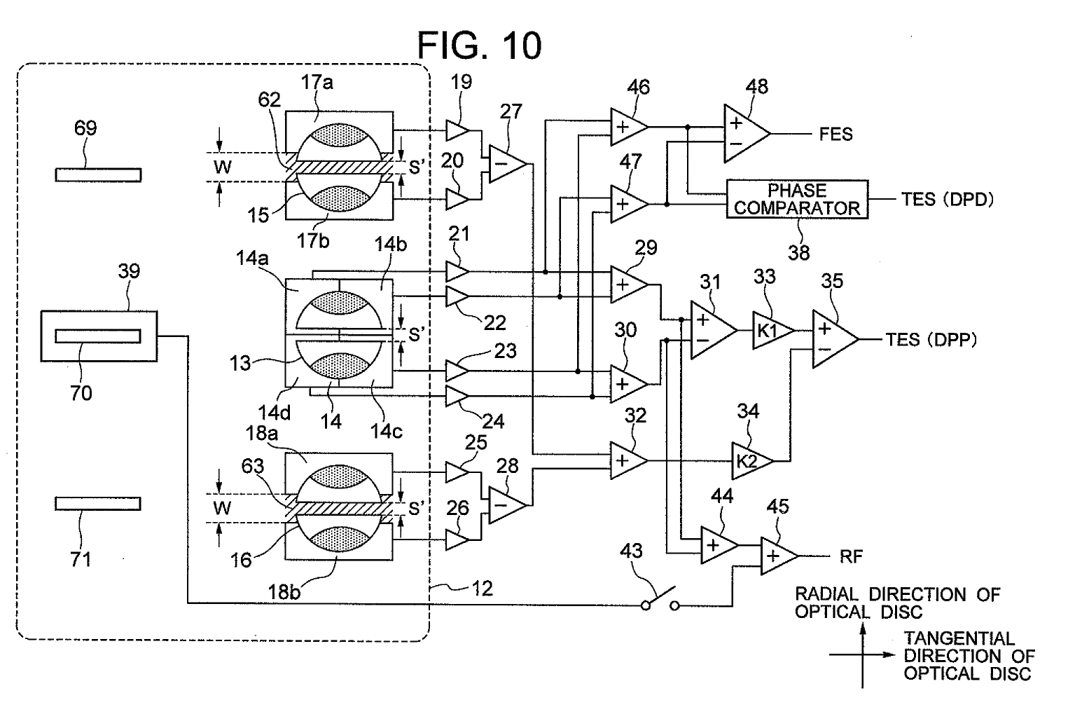

FIG. 7A shows the light intensity distribution on the plane of the optical detector when the objective lens of the optical pickup device of FIG. 1 including the optical element 10 and the optical detector 12 having the light shielding zone or insensitive zones on the light receiving planes of sub beams is not shifted. Dark parts 65, 66 and 67 having no light amount are formed in the main and sub beams by the optical element 10 and diffracted light spots 69, 70 and 71 thereof are directed out of the areas of the light receiving planes 14, 17 and 18 of the optical detector (Diffracted light spots 69, 70 and 71 are shown in FIG. 10). The width S′ of a side in the direction corresponding to the radial direction of the dark parts 65, 66 and 67 is decided by the length S.

The spectral ratio of the diffraction area 60 may be subjected to various setting, although it is preferable that the diffraction area is brazed so that the light amount is concentrated in the diffracted light of the specific order. FIG. 7A shows an example using the brazed diffraction grating. The quarter wavelength plate 6 and the optical element 6 are mounted within the actuator 9, so that movement of the main and sub beams and the dark parts caused by shift of the objective lens is made while the positional relation therebetween is maintained.

FIG. 7b shows the light intensity distribution on the plane of the optical detector of the optical pickup device of FIG. 1 including the optical detector 12 having the light shielding zone or insensitive zone on the light receiving plane of sub beam and the optical element 10 when the objective lens is shifted. At this time, when attention is paid to the main beam spot 13 on the plane of the optical detector, the beam on the division line of the optical detector forms a dark part 66 having no light amount and even when the spot is moved in the radial direction by shift of the objective lens, the area of the beam incident on the optical detector which takes differential so as to produce the main PP signal is not changed and the offset to the main PP signal can be suppressed. Actually, since there is the offset component of change in the light intensity distribution due to lens shift, offset is produced in the main PP signal slightly. According to the Inventors' study, the dark part is provided by the optical element 10, so that the amount of offset produced can be suppressed to about 30% of that of the prior art. Accordingly, when the width of the dark part of the main beam is not equal to the range of lens shift, the area having the light amount overlaps the division line, so that reduction effect of the offset production amount is lost.

Thus, the shift range of the objective lens of the optical pickup device is defined to be L and the spot movement range on the plane of the optical detector by lens shift is defined to be L′. Further, the width of the spot dark part on the plane of the optical detector formed by the diffraction area 60 is defined to be S′. The relations between S and S′ and between L and L′ are uniquely decided by the structure of the optical pickup device. In the structure of the optical pickup device of FIG. 1 taken as an example of the embodiment, the relations between S and S′ and between L and L′ are uniquely decided by focal distances of the collimator lens 5, the detection lens 11, the optical detector 12 and the like and spaces between components.

If the width S′ of the diffraction area is larger than the spot movement range L′ by lens shift on the plane of the optical detector, that is, if the width S of the diffraction area is larger than the lens shift range L, the area having the light amount does not overlap the division line and accordingly the reduction effect of the offset production amount upon lens shift is obtained. However, when the width S of the diffraction area to the diameter of beam is larger than about 50%, the beam in the PP signal area is diffracted and signal is adversely affected.

Accordingly, if the width S of the diffraction area is longer than the lens shift range L and is within the range shorter than 50% of the diameter of beam, it is effective to suppress the signal offset produced in the main PP signal upon shift of the objective lens. For example, generally, the ratio of the lens shift amount to the diameter of beam requires about 10% or more. Accordingly, the ratio of the width S of the diffraction area to the diameter of beam may be within the range of about 10 to 50%. It is preferable that the width S of the diffraction area and the lens shift range L are substantially equal as a balanced structure in which influence to the amplitude of PP signal can be reduced while the amplification factor K2 is suppressed to be smaller than the spectral ratio of the main and sub beams. With the above structure, the dark part of main beam can be positioned on the division line of the optical detector and offset can be suppressed greatly within the whole area of the lens shift range.

With the above structure, however, since the dark part is also produced in the center by the sub beam, the occurrence amount of offset to lens shift is reduced similarly to the main beam. Accordingly, the amplification factor K2 is not reduced to be about spectral ratio. Hence, it is necessary to increase the offset occurrence amount to lens shift for only the sub PP signal. Therefore, it is preferable that belt-shaped light-shielding zones or insensitive zones 62 and 63 having a width W of a side in the direction corresponding to the radial direction of the optical disc are disposed on center division lines 36 and 37 of the light receiving planes 17 and 18 of the sub beams of the optical detector 12 and in the vicinity thereof.

The provision of the light shielding zones can change the spot area of the sub beam incident on the light receiving plane areas of the optical detector for the sub beams upon lens shift and suppress reduction in the offset occurrence sensitivity of the sub PP signal by the dark parts 65 and 67. It is important that the dark parts 65 and 67 of the sub beams produced by the optical element 10 are concealed by the light shielding zones, so that the dark parts 65 and 67 do not influence the sub PP signal detected. Accordingly, it is preferable that the light shielding zones have the width W so that the dark parts 65 and 67 of the sub beams produced by the optical element 10 are concealed by the light shielding zones upon lens shift.

Accordingly, in order that the dark parts 65 and 67 do not protrude from the light shielding zones upon lens shift, the width W of the light shielding zone is preferably set in consideration of even the movement L′ by lens shift in addition to the width S′ of the diffraction area. However, when the width W of the light shielding zone is larger than about 50% to the beam diameter, the beam in PP signal area is also shielded to thereby adversely affect the detection signal. Accordingly, if the width W of the light shielding zone is within the range longer than the sum (L′+S′) of the movement amount L′ of the sub beam spot on the light receiving plane of sub beam in the lens shift range L and the width S′ of the dark part of the sub beam spot on the plane of the optical detector formed by the diffraction area having the width S of the diffraction area 60 and shorter than 50% of the diameter of the sub beam spot, the offset occurrence sensitivity of the sub PP signal to shift of the objective lens can be increased effectively. For example, when the ratio of the lens shift amount L to the diameter of beam is set to be about 10%, the movement amount L′ is also about 10% to the diameter of the sub beam spot on the light receiving plane of sub beam. As described above, since the ratio of the width S of the diffraction area to the beam diameter is within the range of about 10 to 50%, the width S′ of the dark part of sub beam is within the range of about 10 to 50% to the sub beam spot diameter on the light receiving plane of sub beam geometrically. In this case, the ratio of the width of the light shielding zone to the beam diameter on the light receiving plane is within the range of about 20 to 50%. However, when the wave optical effect is taken into account, the sub beam spot has the light amount distribution in the direction narrower than the width S′ of the dark part of sub beam calculated geometrically. Accordingly, the width W of the light shielding zone may be smaller than the sum (L′+S′) of the width S of the dark part of the sub beam spot calculated geometrically and the movement amount L′ of the sub beam spot on the light receiving plane of sub beam by lens shift. It becomes clear from the Inventors' study that when the effective width S″ of the dark part is taken into account, the width W of the light shielding zone is preferably 20 to 40% smaller than the sum (L′+S′) as the balanced structure having less influence to the amplitude of PP signal while the amplification factor K2 is suppressed to be smaller than the spectral ratio. Accordingly, if the ratio of the width W of the light shielding zone to the spot diameter of sub beam on the light receiving plane is set to be within the range of about 10 to 50%, the satisfactory DPP signal can be obtained in the whole lens shift area.

It is understood from the Inventors' study that the structure of the embodiment is used to suppress the amplification factor K2 to about 40% of that of the prior art (K=about 7.5). Accordingly, leakage of the fluctuation component of the sub PP signal into the DPP signal can be suppressed to about 50 to 60% of the prior-art optical pickup device. The occurrence amount of fluctuation of the sub PP signal is dependent large on scattered mounting position and performance of components or parts and accordingly it is considered that there is large effect even on improvement of yield upon mass production.

As described above, in the embodiment, the optical element 10 having the diffraction area in which parts of the main and sub beams are diffracted and the optical detector 12 having the belt-shaped light shielding zones 62 and 63 of the width W formed on the light receiving planes 17 and 18 of sub beam can be used to cancel the signal offset due to lens shift satisfactorily even when the amplification factor K2 of the signal amplifier for sub beam is smaller than the spectral ratio and detect the tracking error signal by the DPP method satisfactorily. At this time, it is preferable that the belt-shaped diffraction area 60 is provided as shown in FIG. 6 in order to suppress the amplification factor K2 to be small, although the length of the side corresponding to the tangential direction of the optical disc of the diffraction area 60 may not be necessarily longer than the effective diameter of the beam. Accordingly, amplification by the amplifier 34 of the disturbance component by interference with unnecessary light can be suppressed and the tracking error signal having less waveform fluctuation can be detected stably and satisfactorily even upon reproduction/recording of the multi-layered optical disc.

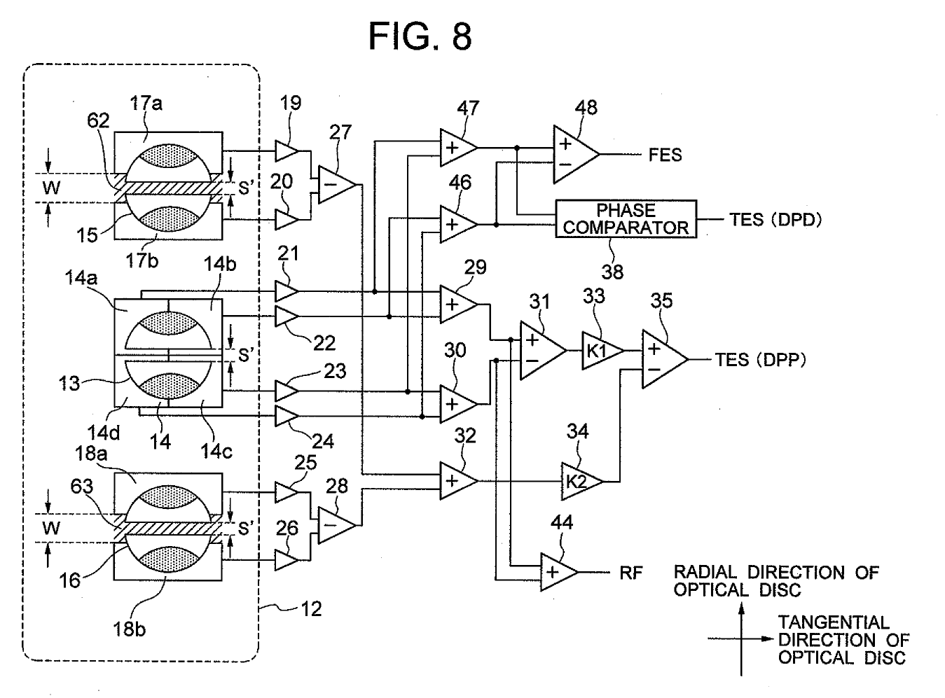

Referring now to FIG. 8, an example of the operation method for producing the pattern of the light receiving plane, the focusing error signal and the tracking error signal of the optical detector 12 described in the embodiment is described.

The light receiving area 14 of main beam is divided into division areas 14a, 14b, 14c and 14d as shown in FIG. 8 and light amount signals obtained from the division areas are A, B, C and D. Further, the light receiving areas 17 and 18 of sub beam are divided into areas 17a, 17b, 18a and 18b and light amount signals obtained from the division areas are I, J, K and L.

An example of the focusing error signal and the tracking error signal in the embodiment is described below. The focusing error signal by the astigmatism method is produced by the following expression:

FES: (A+C)−(B+D)

However, the detection method of the focusing error signal is not limited to the astigmatism method and other methods such as the knife-edge method and the differential astigmatism method may be used. When the differential astigmatism method is used, one division line may be defined on the light receiving plane of sub beam in the direction corresponding to the tangential direction of the optical disc and the light receiving plane may be divided into 4 division areas.

The tracking error signal by the DPP method can be produced by the following expression:

TES(DPP): [(A+B)−(C+D)]−k2[(I−J)+(K−L)]

The tracking error signal by the DPD method can be produced by phase-comparison by a phase comparator 38 of following two signals:

TES(DPD): (A+C), (B+D)

An RF signal is obtained by the following expression:

RF: A+B+C+D

The light shielding zones 62 and 63 can be realized by covering the light receiving planes by material such as aluminum having the light transmittance equal to substantially zero to shield incidence of beam on the light receiving plane. Furthermore, the light shielding material is not limited to material such as aluminum having the light transmittance equal to substantially zero at the whole wavelength band and material having the wavelength selectivity for a predetermined wavelength band in which the light transmittance is substantially equal to zero may be used. The insensitive zone can be realized by deleting the light receiving plane in predetermined parts, for example, since the signal current is not produced even if beam impinges thereon.

Furthermore, the dark part having no light amount occurs even in the unnecessary beam by the diffraction area of the optical element 10.

Consequently, incidence of the unnecessary beam on the detector is suppressed. Accordingly, interference of the unnecessary beam and the signal beam on the optical detector can be suppressed to reduce deterioration of the tracking error signal. In addition, the light shielding zones provided in the sub beam detector can avoid bad influence that unbalance component of the light amount in interference occurring on the light shielding zone affects the quality of sub PP signal.

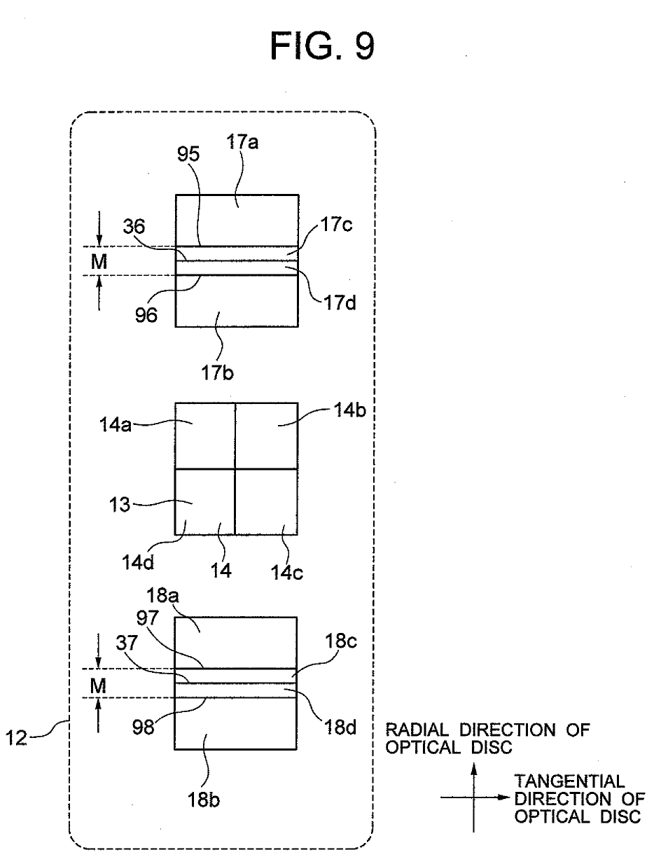

Instead of the provision of the light shielding zones or insensitive zones, the optical detector 12 may be structured as shown in FIG. 9. New division lines 95, 96 and 97, 98 are provided above and below the center division lines 36 and 37 on the light receiving planes for sub beams of the optical detector 12 and substantially parallel to the center division lines and divide the light receiving planes 17 and 18 for sub beam into 4 light receiving areas. The newly divided light receiving areas of the light receiving plane 17 for sub beam are light receiving planes 17a, 17b, 17c and 17d. Similarly, the division areas of the light receiving plane 18 for sub beam are light receiving planes 18a, 18b, 18c and 18d. The spaces M between the newly provided division lines 95, 96 and 97,98 are substantially equal to the width W of the light shielding zone or insensitive zone in the embodiment. At this time, the sub PP signal obtained by adding signals obtained by subtracting signals from the light receiving planes 17a and 17b and signals obtained by subtracting signals from the light receiving planes 18a and 18b, of signals outputted through the current-voltage conversion amplifiers is identical with the sub PP signal obtained from the optical detector of FIG. 8.

An added signal of signals from the light receiving planes 17a and 17c, an added signal of signals from the light receiving planes 17b and 17d, an added signal of signals from the light receiving planes 18a and 18c and an added signal of signals from the light receiving planes 18b and 18d are produced to be subjected to the same operation processing as above to get the same sub PP signal as obtained from the prior-art optical detector shown in FIG. 2. Accordingly, selection as to whether output signals from only the light receiving planes 17a, 17b, 18a and 18b are used or signals obtained by adding the output signals from the light receiving planes 17a, 17b, 18a and 18b to output signals from the light receiving planes 17c, 17d, 18c and 18d are used can be made by means of predetermined switching means, so that both functions of the prior-art optical detector and the optical detector according to the present invention can be provided. Consequently, the functions can be selected in accordance with the number of recording layers of the optical disc to be recorded/reproduced to improve the versatility of the optical pickup device.

More particularly, the optical pickup device of the embodiment can detect the tracking error signal by the DPP method and cancel the signal offset produced upon shift of the objective lens when the amplification factor of the amplifier is smaller than the spectral ratio of the main and sub beams. Moreover, the optical pickup device comprises the optical element which diffracts the beam center parts of the main and sub beams reflected by the optical disc by the belt-shaped diffraction area having a short side in the radial direction of the optical disc into the belt form and the light receiving plane of sub beam for receiving the sub beam of the optical detector is divided by the division line perpendicular to the direction corresponding to the radial direction of the optical disc into 2 areas. Furthermore, the optical pickup device is formed with the light shielding zone for shielding light on the division line and in the vicinity thereof or the insensitive zone in which light on the division line and in the vicinity thereof is not detected. The width of the belt-shaped diffraction area formed on the optical element in the radial direction of the optical disc may be within the range longer than the range in which the objective lens can be shifted and shorter than 50% of the diameter of the beam, and the width of the light shielding zone or the insensitive zone formed in the light receiving plane of sub beam in the direction corresponding to the radial direction of the optical disc may be within the range longer than the sum of an effective width considering even wave optical influence in the direction corresponding to the radial direction of the optical disc of the dark area formed by the diffraction effect of the optical element in the focused spot of the sub beam irradiated on the light receiving plane of sub beam and the maximum movement amount of the focused spot of the sub beam irradiated on the light receiving plane of sub beam by shift of the objective lens and shorter than 50% of the diameter of the focused spot of sub beam irradiated on the light receiving plane of sub beam. The optical pickup device of the embodiment can suppress degradation in quality of the tracking error signal caused by interference of unnecessary beam caused by recording layers except the target layer for reproduction or recording and the original signal beam when a information signal is reproduced from the optical disc having the recording layers in the multi-layered form or is recorded in the recording layer to detect the tracking error signal stably with high accuracy.

### Embodiment 2

A second embodiment is now described with reference to FIG. 10.

In the embodiment, the provision of the means capable of satisfactorily canceling the offset produced upon lens shift even when the amplification factor K2 of the amplifier 34 in the first embodiment is smaller than the spectral ratio and detecting the tracking error signal by the DPP method provides the optical pickup device which can get the information reproduction signal with higher quality than that of first embodiment while maintaining the effects capable of suppressing amplification of interferential disturbance component of unnecessary light by the amplifier and stably detecting the tracking error signal with less waveform fluctuation satisfactorily even upon reproduction/recording of the multi-layered optical disc.

The optical system configuration of the optical pickup device of the embodiment may be the same as that of the optical pickup device shown in FIG. 1, for example. The embodiment is different in the light receiving pattern in the optical detector 12 from that of FIG. 1. FIG. 10 is a schematic diagram illustrating the optical detector 12 which is a primary part of the second embodiment.

In addition to the configuration of the optical detector in the first embodiment, the second embodiment comprises a new optical detector 39 dedicated to detect the RF signal as shown in FIG. 10 and the optical detector 39 detects the light amount in a main beam diffraction spot 70 produced by the optical element 10. When the signal obtained from the RF dedicated light receiving plane is R, the signal R can be added to the RF signal obtained from the main beam receiving plane 14 to calculate the RF signal by the following expression:

RF: A+B+C+D+R

Consequently, even the beam 70 which cannot be received in the main beam receiving plane by diffraction effected by the optical element 10 can be received by the new optical detector 39 and added to the RF signal, so that more satisfactory information reproduction signal can be obtained. The tracking error signal and the focusing error signal may be produced by the same operation method as the first embodiment.

Furthermore, selection as to whether the output signal from the optical detector 39 is added to the RF signal or the signal obtained only from the main beam receiving plane 14 is used as the RF signal can be made by predetermined switching means 43, so that both functions of the prior-art optical detector and the optical detector according to the present invention can be provided. Consequently, the versatility of the optical pickup device is improved.

As described above, in the embodiment, the optical detector 12 is structured as shown in FIG. 10 in the same optical system as the first embodiment, so that there is the merit that there can be provided the optical pickup device capable of obtaining the more satisfactory information reproduction signal than the first embodiment.

More particularly, in the embodiment, the optical pickup device newly provided with the dedicated optical detector for receiving light diffracted by the optical element in addition to the same structure as the first embodiment is used, so that there is the merit that there can be provided the optical pickup device capable of obtaining the more satisfactory information reproduction signal in the same optical system as the first embodiment.

### Embodiment 3

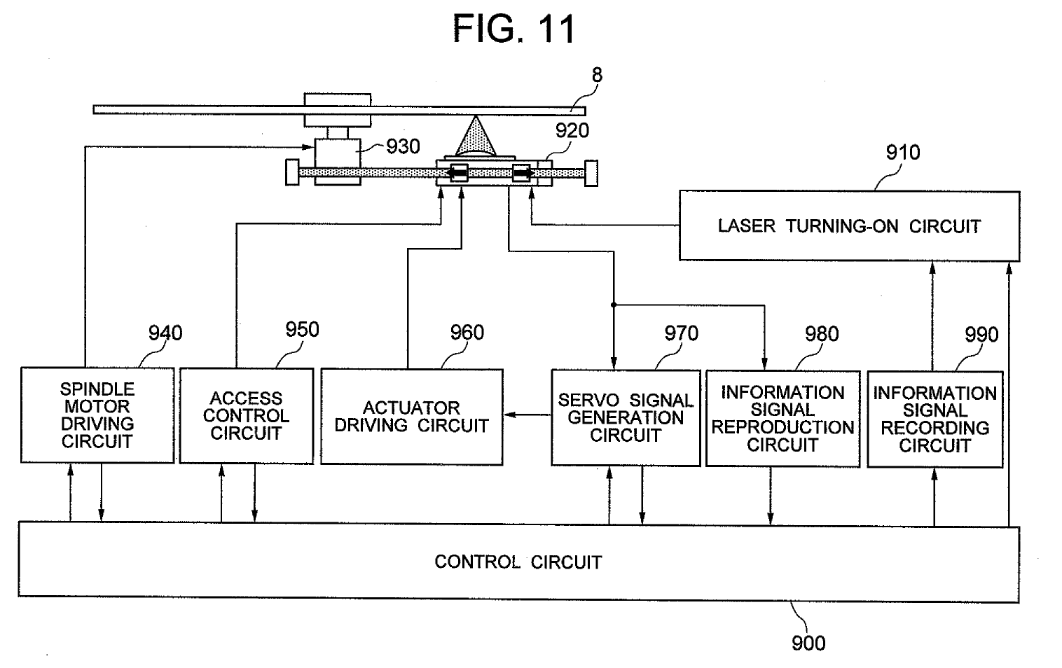

FIG. 11 is a schematic diagram illustrating an optical disc apparatus including the optical pickup device mounted therein according to the first and second embodiments. Numeral 8 denotes an optical disc, 910 a laser turning-on circuit, 920 an optical pickup device, 930 a spindle motor, 940 a spindle motor driving circuit, 950 an access control circuit, 960 an actuator driving circuit, 970 a servo signal generation circuit, 980 an information signal reproduction circuit, 990 an information signal recording circuit and 900 a control circuit. The control circuit 900, the servo signal generation circuit 970 and the actuator driving circuit 960 controls the actuator in response to an output from the optical pickup device 920. The output from the optical pickup device according to the present invention can be used to perform recording/reproduction of information stably with high accuracy.

Furthermore, the optical pickup device used in the present invention is not limited to the optical system as shown in FIG. 1 and the structure of the optical system or the light receiving plane described in the embodiments.

With the measures described above, when the information signal is reproduced from the optical disc having recording layers in the multi-layered form or the information signal is recorded in the recording layer thereof, reduction in the quality of the tracking error signal caused by interference of unnecessary beam caused by the recording layers except the target layer for reproduction or recording and the original signal beam can be improved satisfactorily and the tracking error signal can be detected stably with high accuracy.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

1. An optical pickup device comprising:
a laser light source;
a beam division element to divide a laser beam emitted from the laser light source into main and sub beams;
an objective lens to focus the main and sub beams on an optical disc;
an actuator including the objective lens mounted therein to drive the objective lens in a predetermined direction;
a beam splitter disposed on an optical path between the laser light source and the objective lens to separate outgoing beam traveling from the laser light source toward the objective lens and return beam reflected by the optical disc;
an optical detector to receive the main and sub beams; and
an amplifier to amplify an signal obtained from a light detection plane for the sub beam which receives the sub beam of the optical detector; wherein
signal offset generated upon shift of the objective lens being canceled in case where an amplification factor of the amplifier is smaller than a spectral ratio of the main and sub beams when a tracking error signal is produced from an output signal of the optical detector by predetermined operation.

2. An optical pickup device according to claim 1, further comprising:
an optical element to diffract beam center parts of the main and sub beams reflected by the optical disc by means of belt-shaped diffraction areas having a short side in radial direction of the optical disc into a belt-shape; wherein
the light receiving plane for the sub beam being divided by a division line perpendicular to a direction corresponding to the radial direction of the optical disc into two areas and a light shielding zone to shield light on the division line and in vicinity thereof or an insensitive zone in which light on the division line and in the vicinity thereof is not detected being formed.

3. An optical pickup device according to claim 1, wherein
width of the belt-shaped diffraction area formed in the optical element in the radial direction of the optical disc is within a range longer than a range in which the objective lens can be shifted and shorter than 50% of a diameter of beam.

4. An optical pickup device according to claim 1, wherein
width of light shielding zone or insensitive zone formed on the light receiving plane for the sub beam in direction corresponding to radial direction of the optical disc is within a range longer than the sum of effective width considering even wave optical influence in direction corresponding to the radial direction of the optical disc of dark area formed by diffraction effect of optical element in focused spot of the sub beam irradiated on the light receiving plane of sub beam and maximum movement amount of the focused spot of the sub beam irradiated on the light receiving plane of sub beam by shift of the objective lens and shorter than 50% of diameter of the focused spot of sub beam irradiated on the light receiving plane of sub beam.

5. An optical pickup device according to claim 1, wherein
width of belt-shaped diffraction area formed in optical element in radial direction of the optical disc is within a range of 10 to 50% of diameter of beam.

6. An optical pickup device according to claim 1, wherein
width of light shielding zone or insensitive zone formed on the light receiving plane of sum beam in direction corresponding to radial direction of the optical disc is within range of 10 to 50% of diameter of focused spot of sub beam irradiated on the light receiving plane of sub beam.

7. An optical pickup device according to claim 1, wherein
the signal detected from the light receiving plane for sub beam and amplified is sub PP signal and
the tracking error signal produced by the predetermined operation is a tracking error signal by DPP method.

8. An optical pickup device according to claim 1, wherein
the optical element is disposed in the actuator and includes a polarized grating formed in diffraction area.

9. An optical pickup device according to claim 1, comprising:
a quarter wavelength plate disposed between the objective lens and optical element disposed in the actuator.

10. An optical pickup device according to claim 1, wherein
optical element is brazed so that light intensity is concentrated on diffracted light of predetermined order.

11. An optical pickup device according to claim 1, comprising:
an optical detector dedicated to receive light diffracted by an optical element.

12. An optical pickup device according to claim 1, comprising function of reproducing information signals recorded in a plurality of recording layers formed in the optical disc at predetermined spaces and function of recording information signals in the recording layers.

13. An optical disc apparatus comprising the optical pickup device according to claim 1, a laser turning-on circuit to drive the laser light source in the optical pickup device, a servo signal generation circuit to generate a focusing error signal and a tracking error signal using a signal detected from the optical detector in the optical pickup device, and an information signal reproduction circuit to reproduce an information signal recorded in the optical disc.

14. An optical disc apparatus according to claim 13, comprising function of reproducing information signals recorded in a plurality of recording layers formed in the optical disc at predetermined spaces and function of recording information signals in the recording layers.
